(19) United States
(12) Patent Application Publication
(10) Pub. No.: US 2024/0097744 A1
(43) Pub. Date: Mar. 21, 2024

(54) Systems and Methods for Controlling Reconfigurable Intelligent Surfaces

(71) Applicant: Apple Inc., Cupertino, CA (US)

(72) Inventors: Ankit Bhamri, Bavaria (DE); Danila Zaev, Munich (DE); Bertram R Gunzelmann, Koenigsbrunn (DE); Sharad Sambhwani, San Diego, CA (US)

(21) Appl. No.: 18/464,161

(22) Filed: Sep. 8, 2023

Related U.S. Application Data
(60) Provisional application No. 63/407,109, filed on Sep. 15, 2022.

(51) Int. Cl. H04B 7/04; H04B 7/06

(52) U.S. Cl. CPC H04B 7/04013; H04B 7/0628; H04B 7/063

(57) ABSTRACT

A system may include an access point (AP), user equipment (UE), and a reconfigurable intelligent surface (RIS). The RIS may include an array of elements coupled to adjustable devices controlled to cause the array to reflect signals in different directions. The RIS may be controlled in a first mode in which the AP controls the adjustable devices, a second mode in which the UE controls the adjustable devices, and a third mode in which the RIS controls the adjustable devices. The RIS, AP, or UE may determine which mode to place the RIS in based on a downlink signal transmitted by the AP, an uplink signal transmitted by the UE, measurements of the signals performed on the RIS, a first distance or round trip time between the AP and the RIS, and/or a second distance or round trip time between the UE and the RIS.

This application claims the benefit of U.S. Provisional Patent Application No. 63/407,109, filed Sep. 15, 2022, which is hereby incorporated by reference herein in its entirety.

### FIELD

This disclosure relates generally to electronic devices and, more particularly, to electronic devices with wireless circuitry.

### BACKGROUND

Electronic devices are often provided with wireless capabilities. An electronic device with wireless capabilities has wireless circuitry that includes one or more antennas. The wireless circuitry is used to perform communications using radio-frequency signals conveyed by the antennas.

As software applications on electronic devices become more data-intensive over time, demand has grown for electronic devices that support wireless communications at higher data rates. However, the maximum data rate supported by electronic devices is limited by the frequency of the radio-frequency signals. As the frequency of the radio-frequency signals increases, it can become increasingly difficult to perform satisfactory wireless communications because the signals become subject to significant over-the-air attenuation and typically require line-of-sight.

### SUMMARY

A communication system may include a wireless access point (AP), a user equipment (UE) device, and a reconfigurable intelligent surface (RIS). The RIS may include an array of scattering elements that are coupled to adjustable devices. The adjustable devices may be controlled to impart the array with different impedances, causing the array to reflect wireless signals in different directions between the AP and the UE device. The RIS may be operable in a first control mode in which the AP controls the adjustable devices, a second control mode in which the UE device controls the adjustable devices, and a third control mode in which the controller on the RIS controls the adjustable devices.

The RIS, the AP, or the UE device may determine whether to place the RIS in the first, second, or third control modes based on a downlink (DL) reference signal transmitted by the AP, an uplink (UL) reference signal transmitted by the UE device, and measurements of the DL and/or UL reference signals performed on the RIS. Additionally or alternatively, the AP may determine whether to place the RIS in the first, second, or third control modes based on a first distance or round trip time between the AP and the RIS and a second distance or round trip time between the UE device and the RIS. The round trip times may be identified by placing the RIS into a retro-reflection mode, transmitting signals towards the RIS, and measuring the transmitted signals that reflected off the RIS. The distances may be determined based on radio-frequency spatial ranging, network information, and/or satellite navigation signals. Control signals may be conveyed between the AP and the UE device that identify one or more of the round trip times or distances. Control signals may be conveyed between the RIS, the AP, and the UE device informing each of the devices of the selected control mode. The control mode may be monitored and updated over time.

An aspect of the disclosure provides a first electronic device configured to reflect wireless signals between a second electronic device and a third electronic device. The first electronic device can include an array of scattering elements. The first electronic device can include adjustable devices coupled to the array of scattering elements. The first electronic device can include one or more processors, the one or more processors being configured to, at a first time, program the adjustable devices based on a first control signal received from the second electronic device, and at a second time, program the adjustable devices based on a second control signal received from the third electronic device.

An aspect of the disclosure provides a method of operating a first electronic device to communicate with a second electronic device via reflection of radio-frequency signals off a reconfigurable intelligent surface (RIS). The method can include receiving, from the RIS, a report identifying a first measurement performed on the radio-frequency signals by the RIS. The method can include receiving, via reflection off the RIS, a reference signal transmitted by the second electronic device. The method can include performing a second measurement on the received reference signal. The method can include transmitting, to the second electronic device, a signal identifying a control mode of the RIS that is selected based on the first measurement and the second measurement.

An aspect of the disclosure provides a method of operating a first electronic device to communicate with a second electronic device via reflection of radio-frequency signals off a reconfigurable intelligent surface (RIS). The method can include with one or more processors, identifying a first distance between the first electronic device and the RIS. The method can include with the one or more processors, identifying a second distance between the second electronic device and the RIS. The method can include transmitting, to the second electronic device, a signal identifying a control mode of the RIS that is selected based on the first distance and the second distance.

### BRIEF DESCRIPTION OF THE DRAWINGS

FIG. 1 is a schematic block diagram of an illustrative communications system having a user equipment (UE) device, external communications equipment, and a reconfigurable intelligent surface (RIS) in accordance with some embodiments.

FIG. 2 is a diagram showing how an illustrative wireless access point, RIS, and user equipment device may communicate using both a data transfer radio access technology (RAT) and a control RAT in accordance with some embodiments.

FIG. 3 is a diagram showing how an illustrative RIS may have antenna elements that are controlled to exhibit different impedances for reflecting incident wireless signals in accordance with some embodiments.

FIG. 4 is a state diagram of illustrative control modes (states) for controlling a RIS to reflect wireless signals between first and second devices in accordance with some embodiments.

FIG. 5 is a flow chart of illustrative operations involved in operating a communications system having a RIS to reflect wireless signals between first and second devices in accordance with some embodiments.

FIG. 6 is a flow chart of illustrative operations involved in using a RIS to select a control mode for the RIS in accordance with some embodiments.

FIG. 7 is a flow chart of illustrative operations involved in using a wireless access point to select a control mode for a RIS in accordance with some embodiments.

FIG. 8 is a flow chart of illustrative operations involved in user a user equipment device to select a control mode for a RIS in accordance with some embodiments.

FIG. 9 is a flow chart of illustrative operations involved in using round trip time measurements to select a control mode for a RIS in accordance with some embodiments.

FIG. 10 is a flow chart of illustrative operations involved in using distance measurements to select a control mode for a RIS in accordance with some embodiments.

### DETAILED DESCRIPTION

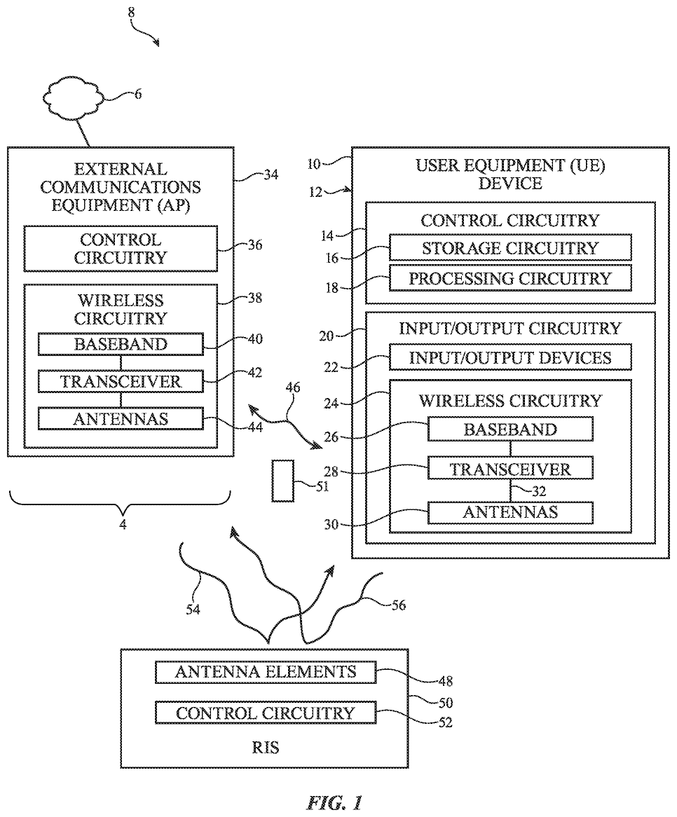

FIG. 1 is a schematic diagram of an illustrative communications system 8 (sometimes referred to herein as communications network 8) for conveying wireless data between communications terminals. Communications system 8 may include network nodes (e.g., communications terminals). The network nodes may include user equipment (UE) such as one or more UE devices 10. The network nodes may also include external communications equipment (e.g., communications equipment other than UE devices 10) such as external communications equipment 34. External communications equipment 34 (sometimes referred to herein simply as external equipment 34) may include one or more electronic devices and may be a wireless base station, wireless access point, or other wireless equipment for example. An implementation in which external communications equipment 34 forms a wireless access point (AP) or wireless base station (gNB) is described herein as an example. External communications equipment 34 may sometimes be referred to herein as AP 34 for the sake of simplicity. UE device 10 and AP 34 may communicate with each other using one or more wireless communications links. If desired, UE devices 10 may wirelessly communicate with AP 34 without passing communications through any other intervening network nodes in communications system 8 (e.g., UE devices 10 may communicate directly with AP 34 over-the-air).

AP 34 may be communicably coupled to one or more other network nodes 6 in a larger communications network 4 via wired and/or wireless links. Network 4 may include one or more wired communications links (e.g., communications links formed using cabling such as ethernet cables, radio-frequency cables such as coaxial cables or other transmission lines, optical fibers or other optical cables, etc.), one or more wireless communications links (e.g., short range wireless communications links that operate over a range of inches, feet, or tens of feet, medium range wireless communications links that operate over a range of hundreds of feet, thousands of feet, miles, or tens of miles, and/or long range wireless communications links that operate over a range of hundreds or thousands of miles, etc.), communications gateways, wireless access points, base stations, switches, routers, servers, modems, repeaters, telephone lines, network cards, line cards, portals, user equipment (e.g., computing devices, mobile devices, etc.), etc. Network 4 may include communications (network) nodes or terminals coupled together using these components or other components (e.g., some or all of a mesh network, relay network, ring network, local area network, wireless local area network, personal area network, cloud network, star network, tree network, or networks of communications nodes having other network topologies), the Internet, combinations of these, etc. UE devices 10 may send data to and/or may receive data from other nodes or terminals in network 4 via AP 34 (e.g., AP 34 may serve as an interface between user equipment devices 10 and the rest of the larger communications network). Network 4 may be managed, operated, controlled, or run by a corresponding network service provider (e.g., a cellular network carrier).

User equipment (UE) device 10 of FIG. 1 is an electronic device (sometimes referred to herein as electronic device 10 or device 10) and may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, equipment that implements the functionality of two or more of these devices, or other electronic equipment.

As shown in the functional block diagram of FIG. 1, UE device 10 may include components located on or within an electronic device housing such as housing 12. Housing 12, which may sometimes be referred to as a case, may be formed of plastic, glass, ceramics, fiber composites, metal (e.g., stainless steel, aluminum, metal alloys, etc.), other suitable materials, or a combination of these materials. In some situations, part or all of housing 12 may be formed from dielectric or other low-conductivity material (e.g., glass, ceramic, plastic, sapphire, etc.). In other situations, housing 12 or at least some of the structures that make up housing 12 may be formed from metal elements.

UE device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols, optical communications protocols, or any other desired communications protocols. Each communications protocol may be associated with a corresponding radio access technology (RAT) that specifies the physical connection methodology used in implementing the protocol.

UE device 10 may include input-output circuitry 20. Input-output circuitry 20 may include input-output devices 22. Input-output devices 22 may be used to allow data to be supplied to UE device 10 and to allow data to be provided from UE device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to UE device 10 using wired or wireless connections (e.g., some of input-output devices 22 may be peripherals that are coupled to a main processing unit or other portion of UE device 10 via a wired or wireless link).

Input-output circuitry 20 may include wireless circuitry 24 to support wireless communications. Wireless circuitry 24 (sometimes referred to herein as wireless communications circuitry 24) may include baseband circuitry such as baseband circuitry 26 (e.g., one or more baseband processors and/or other circuitry that operates at baseband), radio-frequency (RF) transceiver circuitry such as transceiver 28, and one or more antennas 30. If desired, wireless circuitry 24 may include multiple antennas 30 that are arranged into a phased antenna array (sometimes referred to as a phased array antenna) that conveys radio-frequency signals within a corresponding signal beam that can be steered in different directions. Baseband circuitry 26 may be coupled to transceiver 28 over one or more baseband data paths. Transceiver 28 may be coupled to antennas 30 over one or more radio-frequency transmission line paths 32. If desired, radio-frequency front end circuitry may be disposed on radio-frequency transmission line path(s) 32 between transceiver 28 and antennas 30.

In the example of FIG. 1, wireless circuitry 24 is illustrated as including only a single transceiver 28 and a single radio-frequency transmission line path 32 for the sake of clarity. In general, wireless circuitry 24 may include any desired number of transceivers 28, any desired number of radio-frequency transmission line paths 32, and any desired number of antennas 30. Each transceiver 28 may be coupled to one or more antennas 30 over respective radio-frequency transmission line paths 32. Radio-frequency transmission line path 32 may be coupled to antenna feeds on one or more antenna 30. Each antenna feed may, for example, include a positive antenna feed terminal and a ground antenna feed terminal. Radio-frequency transmission line path 32 may have a positive transmission line signal path that is coupled to the positive antenna feed terminal and may have a ground transmission line signal path that is coupled to the ground antenna feed terminal. This example is merely illustrative and, in general, antennas 30 may be fed using any desired antenna feeding scheme.

Radio-frequency transmission line path 32 may include transmission lines that are used to route radio-frequency antenna signals within device 10. Transmission lines in device 10 may include coaxial cables, microstrip transmission lines, stripline transmission lines, edge-coupled microstrip transmission lines, edge-coupled stripline transmission lines, transmission lines formed from combinations of transmission lines of these types, etc. Transmission lines in device 10 such as transmission lines in radio-frequency transmission line path 32 may be integrated into rigid and/or flexible printed circuit boards. In one embodiment, radio-frequency transmission line paths such as radio-frequency transmission line path 32 may also include transmission line conductors integrated within multilayer laminated structures (e.g., layers of a conductive material such as copper and a dielectric material such as a resin that are laminated together without intervening adhesive). The multilayer laminated structures may, if desired, be folded or bent in multiple dimensions (e.g., two or three dimensions) and may maintain a bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive).

In performing wireless transmission, baseband circuitry 26 may provide baseband signals to transceiver 28 (e.g., baseband signals that include wireless data for transmission). Transceiver 28 may include circuitry for converting the baseband signals received from baseband circuitry 26 into corresponding radio-frequency signals (e.g., for modulating the wireless data onto one or more carriers for transmission, synthesizing a transmit signal, etc.). For example, transceiver 28 may include mixer circuitry for up-converting the baseband signals to radio frequencies prior to transmission over antennas 30. Transceiver 28 may also include digital to analog converter (DAC) and/or analog to digital converter (ADC) circuitry for converting signals between digital and analog domains. Transceiver 28 may transmit the radio-frequency signals over antennas 30 via radio-frequency transmission line path 32. Antennas 30 may transmit the radio-frequency signals to external wireless equipment by radiating the radio-frequency signals into free space.

In performing wireless reception, antennas 30 may receive radio-frequency signals from AP 34. The received radio-frequency signals may be conveyed to transceiver 28 via radio-frequency transmission line path 32. Transceiver 28 may include circuitry for converting the received radio-frequency signals into corresponding baseband signals. For example, transceiver 28 may include mixer circuitry for down-converting the received radio-frequency signals to baseband frequencies prior to conveying the baseband signals to baseband circuitry 26 and may include demodulation circuitry for demodulating wireless data from the received signals.

Front end circuitry disposed on radio-frequency transmission line path 32 may include radio-frequency front end components that operate on radio-frequency signals conveyed over radio-frequency transmission line path 32. If desired, the radio-frequency front end components may be formed within one or more radio-frequency front end modules (FEMs). Each FEM may include a common substrate such as a printed circuit board substrate for each of the radio-frequency front end components in the FEM. The radio-frequency front end components in the front end circuitry may include switching circuitry (e.g., one or more radio-frequency switches), radio-frequency filter circuitry (e.g., low pass filters, high pass filters, notch filters, band pass filters, multiplexing circuitry, duplexer circuitry, diplexer circuitry, triplexer circuitry, etc.), impedance matching circuitry (e.g., circuitry that helps to match the impedance of antennas 30 to the impedance of radio-frequency transmission line path 32), antenna tuning circuitry (e.g., networks of capacitors, resistors, inductors, and/or switches that adjust the frequency response of antennas 30), radio-frequency amplifier circuitry (e.g., power amplifier circuitry and/or low-noise amplifier circuitry), radio-frequency coupler circuitry, charge pump circuitry, power management circuitry, digital control and interface circuitry, and/or any other desired circuitry that operates on the radio-frequency signals transmitted and/or received by antennas 30.

While control circuitry 14 is shown separately from wireless circuitry 24 in the example of FIG. 1 for the sake of clarity, wireless circuitry 24 may include processing circuitry that forms a part of processing circuitry 18 and/or storage circuitry that forms a part of storage circuitry 16 of control circuitry 14 (e.g., portions of control circuitry 14 may be implemented on wireless circuitry 24). As an example, baseband circuitry 26 and/or portions of transceiver 28 (e.g., a host processor on transceiver 28) may form a part of control circuitry 14. Baseband circuitry 26 may, for example, access a communication protocol stack on control circuitry 14 (e.g., storage circuitry 16) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

The term “convey wireless signals” as used herein means the transmission and/or reception of the wireless signals (e.g., for performing unidirectional and/or bidirectional wireless communications with external wireless communications equipment). Antennas 30 may transmit the wireless signals by radiating the signals into free space (or to free space through intervening device structures such as a dielectric cover layer). Antennas 30 may additionally or alternatively receive the wireless signals from free space (e.g., through intervening devices structures such as a dielectric cover layer). The transmission and reception of wireless signals by antennas 30 each involve the excitation or resonance of antenna currents on an antenna resonating (radiating) element in the antenna by the wireless signals within the frequency band(s) of operation of the antenna.

Transceiver circuitry 26 may use antenna(s) 30 to transmit and/or receive wireless signals that convey wireless communications data between device 10 and AP 34 (e.g., one or more other devices such as device 10, a wireless access point or base station, etc.). The wireless communications data may be conveyed bidirectionally or unidirectionally. The wireless communications data may, for example, include data that has been encoded into corresponding data packets such as wireless data associated with a telephone call, streaming media content, internet browsing, wireless data associated with software applications running on device 10, email messages, etc.

Additionally or alternatively, wireless circuitry 24 may use antenna(s) 30 to perform wireless (radio-frequency) sensing operations. The sensing operations may allow device 10 to detect (e.g., sense or identify) the presence, location, orientation, and/or velocity (motion) of objects external to device 10. Control circuitry 14 may use the detected presence, location, orientation, and/or velocity of the external objects to perform any desired device operations. As examples, control circuitry 14 may use the detected presence, location, orientation, and/or velocity of the external objects to identify a corresponding user input for one or more software applications running on device 10 such as a gesture input performed by the user's hand(s) or other body parts or performed by an external stylus, gaming controller, head-mounted device, or other peripheral devices or accessories, to determine when one or more antennas 30 needs to be disabled or provided with a reduced maximum transmit power level (e.g., for satisfying regulatory limits on radio-frequency exposure), to determine how to steer (form) a radio-frequency signal beam produced by antennas 30 for wireless circuitry 24 (e.g., in scenarios where antennas 30 include a phased array of antennas 30), to map or model the environment around device 10 (e.g., to produce a software model of the room where device 10 is located for use by an augmented reality application, gaming application, map application, home design application, engineering application, etc.), to detect the presence of obstacles in the vicinity of (e.g., around) device 10 or in the direction of motion of the user of device 10, etc. The sensing operations may, for example, involve the transmission of sensing signals (e.g., radar waveforms), the receipt of corresponding reflected signals (e.g., the transmitted waveforms that have reflected off of external objects), and the processing of the transmitted signals and the received reflected signals (e.g., using a radar scheme).

Wireless circuitry 24 may transmit and/or receive wireless signals within corresponding frequency bands of the electromagnetic spectrum (sometimes referred to herein as communications bands or simply as “bands”). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, 6G bands at sub-THz or THz frequencies greater than about 100 GHz, etc.), other centimeter or millimeter wave frequency bands between 10-100 GHz, near-field communications frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

Over time, software applications on electronic devices such as device 10 have become more and more data intensive. Wireless circuitry on the electronic devices therefore needs to support data transfer at higher and higher data rates. In general, the data rates supported by the wireless circuitry are proportional to the frequency of the wireless signals conveyed by the wireless circuitry (e.g., higher frequencies can support higher data rates than lower frequencies). Wireless circuitry 24 may convey centimeter and millimeter wave signals to support relatively high data rates (e.g., because centimeter and millimeter wave signals are at relatively high frequencies between around 10 GHz and 100 GHz). However, the data rates supported by centimeter and millimeter wave signals may still be insufficient to meet all the data transfer needs of device 10. To support even higher data rates such as data rates up to 5-100 Gbps or higher, wireless circuitry 24 may convey wireless signals at frequencies greater than about 100 GHz.

As shown in FIG. 1, wireless circuitry 24 may transmit wireless signals 46 to AP 34 and/or may receive wireless signals 46 from AP 34. Wireless signals 46 may be tremendously high frequency (THF) signals (e.g., sub-THz or THz signals) at frequencies greater than around 100 GHz (e.g., between 100 GHz and 1 THz, between 80 GHz and 10 THz, between 100 GHz and 10 THz, between 100 GHz and 2 THz, between 200 GHz and 1 THz, between 300 GHz and 1 THz, between 300 GHz and 2 THz, between 70 GHz and 2 THz, between 300 GHz and 10 THz, between 100 GHz and 800 GHz, between 200 GHz and 1.5 THz, or within any desired sub-THz, THz, THF, or sub-millimeter frequency band such as a 6G frequency band), may be millimeter (mm) or centimeter (cm) wave signals between 10 GHz and around 70 GHz (e.g., 5G NR FR2 signals), or may be signals at frequencies less than 10 GHz (e.g., 5G NR FR1 signals, LTE signals, 3G signals, 2G signals, WLAN signals, Bluetooth signals, UWB signals, etc.). If desired, the high data rates supported by THF signals may be leveraged by device 10 to perform cellular telephone voice and/or data communications (e.g., while supporting spatial multiplexing to provide further data bandwidth), to perform spatial ranging operations such as radar operations to detect the presence, location, and/or velocity of objects external to device 10, to perform automotive sensing (e.g., with enhanced security), to perform health/body monitoring on a user of device 10 or another person, to perform gas or chemical detection, to form a high data rate wireless connection between device 10 and another device or peripheral device (e.g., to form a high data rate connection between a display driver on device 10 and a display that displays ultra-high resolution video), to form a remote radio head (e.g., a flexible high data rate connection), to form a THF chip-to-chip connection within device 10 that supports high data rates (e.g., where one antenna 30 on a first chip in device 10 transmits THF signals 32 to another antenna 30 on a second chip in device 10), and/or to perform any other desired high data rate operations.

In implementations where wireless circuitry 24 conveys THF signals, wireless circuitry may include electro-optical circuitry if desired. The electro-optical circuitry may include light sources that generate first and second optical local oscillator (LO) signals. The first and second optical LO signals may be separated in frequency by the intended frequency of wireless signals 46. Wireless data may be modulated onto the first optical LO signal and one of the optical LO signals may be provided with an optical phase shift (e.g., to perform beamforming). The first and second optical LO signals may illuminate a photodiode that produces current at the frequency of wireless signals 46 when illuminated by the first and second optical LO signals. An antenna resonating element of a corresponding antenna 30 may convey the current produced by the photodiode and may radiate corresponding wireless signals 46. This is merely illustrative and, in general, wireless circuitry 24 may generate wireless signals 46 using any desired techniques.

Antennas 30 may be formed using any desired antenna structures. For example, antennas 30 may include antennas with resonating elements that are formed from loop antenna structures, patch antenna structures, inverted-F antenna structures, slot antenna structures, planar inverted-F antenna structures, helical antenna structures, monopole antennas, dipoles (e.g., planar dipole antennas such as bowtie antennas), hybrids of these designs, etc. Parasitic elements may be included in antennas 30 to adjust antenna performance.

If desired, two or more of antennas 30 may be integrated into a phased antenna array (sometimes referred to herein as a phased array antenna or an array of antenna elements). Each antenna 30 in the phased antenna array forms a respective antenna element of the phased antenna array. Each antenna 30 in the phased antenna array has a respective phase and magnitude controller that imparts the radio-frequency signals conveyed by that antenna with a respective phase and magnitude. The respective phases and magnitudes may be selected (e.g., by control circuitry 14) to configure the radio-frequency signals conveyed by the antennas 30 in the phased antenna array to constructively and destructively interfere in such a way that the radio-frequency signals collectively form a signal beam (e.g., a signal beam of wireless signals 46) oriented in a corresponding beam pointing direction (e.g., a direction of peak gain).

The control circuitry may adjust the phases and magnitudes to change (steer) the orientation of the signal beam (e.g., the beam pointing direction) to point in other directions over time. This process may sometimes also be referred to herein as beamforming. Beamforming may boost the gain of wireless signals 46 to help overcome over-the-air attenuation and the signal beam may be steered over time to point towards AP 34 even as the position and orientation of UE device 10 changes. The signal beams formed by antennas 30 of UE device 10 may sometimes be referred to herein as UE beams or UE signal beams. Each UE beam may be oriented in a different respective direction (e.g., a beam pointing direction of peak signal gain). Each UE beam may be labeled by a corresponding UE beam index. UE device 10 may include or store a codebook (sometimes referred to herein as a UE codebook) that maps each of its UE beam indices to the corresponding phase and magnitude settings for each antenna 30 in a phased antenna array that configure the phased antenna array to form the UE beam associated with that UE beam index.

As shown in FIG. 1, AP 34 may also include control circuitry 36 (e.g., control circuitry having similar components and/or functionality as control circuitry 14 in UE device 10) and wireless circuitry 38 (e.g., wireless circuitry having similar components and/or functionality as wireless circuitry 24 in UE device 10). Wireless circuitry 38 may include baseband circuitry 40 and transceiver 42 (e.g., transceiver circuitry having similar components and/or functionality as transceiver circuitry 28 in UE device 10) coupled to two or more antennas 44 (e.g., antennas having similar components and/or functionality as antennas 30 in UE device 10). Antennas 44 may be arranged in one or more phased antenna arrays (e.g., phased antenna arrays that perform beamforming similar to phased antenna arrays of antennas 30 on UE device 10).

AP 34 may use wireless circuitry 38 to transmit a signal beam of wireless signals 46 to UE device 10 (e.g., as downlink (DL) signals transmitted in a downlink direction) and/or to receive a signal beam of wireless signals 46 transmitted by UE device 10 (e.g., as uplink (UL) signals transmitted in an uplink direction). The signal beams formed by antennas 44 of UE device 10 may sometimes be referred to herein as AP beams or AP signal beams. Each AP beam may be oriented in a different respective direction (e.g., a beam pointing direction of peak signal gain). Each AP beam may be labeled by a corresponding AP beam index. AP 34 may include or store a codebook (sometimes referred to herein as an AP codebook) that maps each of its AP beam indices to the corresponding phase and magnitude settings for each antenna 44 in a phased antenna array that configure the phased antenna array to form the AP beam associated with that AP beam index.

While communications at high frequencies allow for extremely high data rates (e.g., greater than 100 Gbps), wireless signals 46 at such high frequencies are subject to significant attenuation during propagation over-the-air. Integrating antennas 30 and 44 into phased antenna arrays helps to counteract this attenuation by boosting the gain of the signals within a signal beam. However, signal beams are highly directive and may require a line-of-sight (LOS) between UE device 10 and AP 34. If an external object is present between AP 34 and UE device 10, the external object may block the LOS between UE device 10 and AP 34, which can disrupt wireless communications using wireless signals 46. If desired, an reconfigurable intelligent surface (RIS) may be used to allow UE device 10 and AP 34 to continue to communicate using wireless signals 46 even when an external object blocks the LOS between UE device 10 and AP 34 (or whenever direct over-the-air communications between AP 34 and UE device 10 otherwise exhibits less than optimal performance).

As shown in FIG. 1, system 8 may include one or more reconfigurable intelligent surfaces (RIS's) such as RIS 50. RIS 50 may sometimes also be referred to as an intelligent reconfigurable surface, an intelligent reflective/reflecting surface, a reflective intelligent surface, a reflective surface, a reflective device, a reconfigurable reflective device, a reconfigurable reflective surface, or a reconfigurable surface. AP 34 may be separated from UE device 10 by a line-of-sight (LOS) path. In some circumstances, an external object such as object 51 may block the LOS path. Object 51 may be, for example, part of a building such as a wall, window, floor, or ceiling (e.g., when UE device 10 is located inside), furniture, a body or body part, an animal, a cubicle wall, a vehicle, a landscape feature, or other obstacles or objects that may block the LOS path between AP 34 and UE device 10.

In the absence of external object 51, AP 34 may form a corresponding AP beam of wireless signals 46 oriented in the direction of UE device 10 and UE device 10 may form a corresponding UE beam of wireless signals 46 oriented in the direction of AP 34. UE device 10 and AP 34 can then convey wireless signals 46 over their respective signal beams and the LOS path. However, the presence of external object 51 prevents wireless signals 46 from being conveyed over the LOS path.

RIS 50 may be placed or disposed within system 8 in such a way so as to allow RIS 50 to reflect wireless signals 46 between UE device 10 and AP 34 despite the presence of external object 51 within the LOS path. More generally, RIS 50 may be used to reflect wireless signals 46 between UE device 10 and AP 34 when reflection via RIS 50 offers superior radio-frequency propagation conditions relative to the LOS path regardless of the presence of external object 51 (e.g., when the LOS path between AP 34 and RIS 50 and the LOS path between RIS 50 and UE device 10 exhibit superior propagation/channel conditions than the direct LOS path between UE device 10 and AP 34).

When RIS 50 is placed within system 8, AP 34 may transmit wireless signals 46 towards RIS 50 (e.g., within an AP beam oriented towards RIS 50 rather than towards UE device 10) and RIS 50 may reflect the wireless signals towards UE device 10, as shown by arrow 54. Conversely, UE device 10 may transmit wireless signals 46 towards RIS 50 (e.g., within a UE beam oriented towards RIS 50 rather than towards AP 34) and RIS 50 may reflect the wireless signals towards AP 34, as shown by arrow 56.

RIS 50 is an electronic device that includes a two-dimensional surface of engineered material (e.g., an active metasurface) having reconfigurable properties for performing (e.g., reflecting) communications between AP 34 and UE device 10. RIS 50 may include an array of reflective/scattering elements such as antenna elements 48 on an underlying substrate. Antenna elements 48 may also sometimes be referred to herein as reflective elements 48, scattering elements 48, reconfigurable antenna elements 48, reconfigurable reflective elements 48, reflectors 48, or reconfigurable reflectors 48. The antenna elements 48 in the array may be spaced by distances less than the wavelength reflected by RIS 50, for example.

The substrate may be a rigid or flexible printed circuit board, a package, a plastic substrate, meta-material, or any other desired substrate. The substrate may be planar or may be curved in one or more dimensions. If desired, the substrate and antenna elements 48 may be enclosed within a housing. The housing may be formed from materials that are transparent to wireless signals 46. If desired, RIS 50 may be disposed (e.g., layered) onto an underlying electronic device. RIS 50 may also be provided with mounting structures (e.g., adhesive, brackets, a frame, screws, pins, clips, etc.) that can be used to affix or attach RIS 50 to an underlying structure such as another electronic device, a wall, the ceiling, the floor, furniture, etc. Disposing RIS 50 on a ceiling, wall, window, column, pillar, or at or adjacent to the corner of a room (e.g., a corner where two walls intersect, where a wall intersects with the floor or ceiling, where two walls and the floor intersect, or where two walls and the ceiling intersect), as examples, may be particularly helpful in allowing RIS 50 to reflect wireless signals between AP 34 and UE device 10 around various objects 51 that may be present (e.g., when AP 34 is located outside and UE device 10 is located inside, when AP 34 and UE device 10 are both located inside or outside, etc.).

RIS 50 may be a passive adaptively controlled reflecting surface and a powered device that includes control circuitry 52 that helps to control the operation of antenna elements 48 (e.g., one or more processors in control circuitry such as control circuitry 14). When electro-magnetic (EM) energy waves (e.g., waves of wireless signals 46) are incident on RIS 50, the wave is effectively reflected by each antenna element 48 via scattering (e.g., re-radiation) by each antenna element 48 with a respective phase and amplitude response. Antenna elements 48 may include passive reflectors (e.g., antenna resonating elements or other radio-frequency reflective elements). Each antenna element 48 may include an adjustable device that is programmed, set, and/or controlled by control circuitry 52 (e.g., using a control signal that includes or is associated with a respective beamforming coefficient) to configure that antenna element 48 to reflect incident EM energy with the respective phase and optionally amplitude response. The adjustable device may be a programmable photodiode, an adjustable impedance matching circuit, an adjustable phase shifter, an adjustable amplifier, a varactor diode, an antenna tuning circuit, etc.

Control circuitry 52 on RIS 50 may configure the reflective (scattering) response of antenna elements 48 on a per-element or per-group-of-elements basis (e.g., where each antenna element has a respective programmed phase and amplitude response or the antenna elements in different sets/groups of antenna elements are each programmed to share the same respective phase and amplitude response across the set/group but with different phase and amplitude responses between sets/groups). The scattering, absorption, reflection, and diffraction properties of the entire RIS can therefore be changed over time and controlled (e.g., by software running on the RIS or other devices communicably coupled to the RIS such as external equipment 34 or UE device 10).

One way of achieving the per-element phase and amplitude response of antenna elements 48 is by adjusting the impedance of antenna elements 48, thereby controlling the complex reflection coefficient that determines the change in amplitude and phase of the re-radiated signal. The control circuitry 52 on RIS 50 may configure antenna elements 48 to exhibit impedances that serve to reflect wireless signals 46 incident from particular incident angles onto particular output angles. The antenna elements 48 (e.g., the antenna impedances) may be adjusted (e.g., programed or configured) to change the angle with which incident wireless signals 46 are reflected off of RIS 50. If desired, the antenna elements may also be adjusted to perform any desired refraction, focusing, collimation, and/or modulation upon incident and/or reflected signals.

For example, the control circuitry on RIS 50 may configure antenna elements 48 to reflect wireless signals 46 transmitted by AP 34 towards UE device 10 (as shown by arrow 54) and to reflect wireless signals 46 transmitted by UE device 10 towards AP 34 (as shown by arrow 56). In such an example, control circuitry 36 may configure (e.g., program) a phased antenna array of antennas 44 on AP 34 to form an AP beam oriented towards RIS 50, control circuitry 14 may configure (e.g., program) a phased antenna array of antennas 30 on UE device 10 to form a UE beam oriented towards RIS 50, control circuitry 52 may configure (e.g., program) antenna elements 48 to receive and re-radiate (e.g., effectively reflect) wireless signals incident from the direction of AP 34 towards/onto the direction of UE device 10 (as shown by arrow 54), and control circuitry 52 may configure (e.g., program) antenna elements 48 to receive and re-radiate (e.g., effectively reflect) wireless signals incident from the direction of UE device 10 towards-onto the direction of external equipment 34 (as shown by arrow 56). The antenna elements may be configured using respective beamforming coefficients. Control circuitry 52 on RIS 50 may set and adjust the adjustable devices coupled to antenna elements 48 (e.g., may set and adjust the impedances of antenna elements 48) over time to reflect wireless signals 46 incident from different selected incident angles onto different selected output angles.

To minimize the cost, complexity, and power consumption of RIS 50, RIS 50 may include only the components and control circuitry required to control and operate antenna elements 48 to reflect wireless signals 46. Such components and control circuitry may include, for example, the adjustable devices of antenna elements 48 as required to change the phase and magnitude responses of antenna elements 48 (based on corresponding beamforming coefficients) and thus the direction with which RIS 50 reflects wireless signals 46. The components may include, for example, components that adjust the impedances of antenna elements 48 so that each antenna element exhibits a respective complex reflection coefficient, which determines the phase and amplitude of the reflected (re-radiated) signal produced by each antenna element (e.g., such that the signals reflected across the array constructively and destructively interfere to form a reflected signal beam in a corresponding beam pointing direction).

All other components that would otherwise be present in UE device 10 or AP 34 may be omitted from RIS 50. For example, when implemented as a passive RIS, RIS 50 does not include baseband circuitry (e.g., baseband circuitry 26 or 40) and does not include transceiver circuitry (e.g., transceiver 42 or 28), amplifiers, or transmit/receive chains coupled to antenna elements 48. Antenna elements 48 and RIS 50 therefore do not generate wireless data for transmission, do not synthesize radio-frequency signals for transmission, and do not receive and demodulate radio-frequency signals. In other words, the control circuitry on RIS 50 may adjust antenna elements 48 to direct and steer reflected wireless signals 46 without using antenna elements 48 to perform any data transmission or reception operations and without using antenna elements 48 to perform radio-frequency sensing operations. Passive RIS's include a very low energy source or even no energy source and can be easily deployed into building facades, indoor ceilings, laptop cases, clothing, etc. Passive RIS's may, for example, be particularly suitable for situations when a direct link between AP 34 and UE device 10 is blocked, but exhibit limited gain due to multiplicative path loss and no amplification to the reflected signals.

If desired, RIS 50 may be implemented as an active RIS. An active RIS is a passive RIS that also includes receive and/or transmit chains coupled to one or more of antenna elements 48. The transmit chains may include one or more transmitters, radio-frequency transmission line paths, and/or power amplifiers. The receive chains may include one or more receivers, radio-frequency transmission line paths, and/or low noise amplifiers. Active RIS's consume more power than passive RIS's. However, active RIS's can apply gain to reflected signals (e.g., acting as a repeater) and can actively demodulate/decode wireless data received by antenna elements 48. Active RIS's may, for example, perform measurements on the incident signals (e.g., may gather wireless performance metric data from the incident signals). All other components of UE device 10 or AP 34 may be omitted from the active RIS's to conserve power if desired. For example, RIS 50 (whether passive or active) may be implemented without a display or user input device.

This may serve to minimize the hardware cost and power consumption of RIS 50. If desired, RIS 50 may also include one or more antennas separate from the antenna elements 48 used to reflect wireless signals 46, as well as corresponding transceiver/baseband circuitry that uses the one or more antennas to convey control signals with AP 34 or UE device 10 (e.g., using a control channel plane and control RAT). Such control signals may be used to coordinate the operation of RIS 50 in conjunction with AP 34 and/or UE device 10 but requires much lower data rates and thus much fewer processing resources and much less power than transmitting or receiving wireless signals 46. These control signals may, for example, be transmitted by UE device 10 and/or AP 34 to configure the phase and magnitude (impedance) responses of antenna elements 48 (e.g., the control signals may convey beamforming coefficients).

In this way, RIS 50 may help to relay wireless signals 46 between AP 34 and UE device 10 when object 51 blocks the LOS path between AP 34 and UE device 10 and/or when the propagation conditions from AP 34 to RIS 50 and from RIS 50 to UE device 10 are otherwise superior to the propagation conditions from AP 34 to UE device 10. Just a single RIS 50 may, for example, increase signal-to-interference-plus-noise ratio (SINR) for UE device 10 by as much as +20 dB and may increase effective channel rank relative to environments without an RIS. At the same time, RIS 50 only includes processing resources and consumes power required to perform the necessary control procedures, minimizing the cost of RIS 50 and maximizing the flexibility with which RIS 50 can be placed within the environment.

RIS 50 may include or store a codebook (sometimes referred to herein as a RIS codebook) that maps settings for antenna elements 48 to different reflected signal beams formable by antenna elements 48 (sometimes referred to herein as RIS beams). The beamforming performed at RIS 50 may sometimes be referred to herein as including two concurrently active RIS beams (e.g., where each RIS beam is generated using a corresponding set of beamforming coefficients). In general, RIS 50 may relay (reflect) signals between two different devices. RIS 50 may form a first active RIS beam that has a beam pointing direction oriented towards the first device (sometimes referred to here as a RIS-AP beam when the first device is AP 34) and may concurrently form a second active RIS beam that has a beam pointing direction oriented towards the second device (sometimes referred to herein as a RIS-UE beam when the second device is UE device 10). In this way, when wireless signals 46 are incident from the first device (e.g., AP 34) within the first RIS beam, the antenna elements 48 on RIS 50 may receive the wireless signals incident from the direction the first device (e.g., AP 34) and may re-radiate (e.g., effectively reflect or scatter) the incident wireless signals within the second RIS beam and towards the direction of the second device (e.g., UE device 10). Conversely, when wireless signals 46 are incident from the second device (e.g., UE device 10) within the second RIS beam, the antenna elements 48 on RIS 50 may receive the wireless signals incident from the direction the second device (e.g., UE device 10) and may re-radiate (e.g., effectively reflect) the incident wireless signals within the first RIS beam and towards the direction of the first device (e.g., AP 34).

While referred to herein as “beams,” the first RIS beam and the second RIS beams formed by RIS 50 do not include signals/data that are actively transmitted by RIS 50 but instead correspond to the impedance, phase, and/or magnitude response settings (e.g., reflection coefficients) for antenna elements 48 that shape the reflected signal beam of wireless signals 46 from a corresponding incident direction/angle onto a corresponding output direction/angle (e.g., the first RIS beam may be effectively formed using a first set of beamforming coefficients and the second RIS beam may be effectively formed using a second set of beamforming coefficients but are not associated with the active transmission of wireless signals by RIS 50).

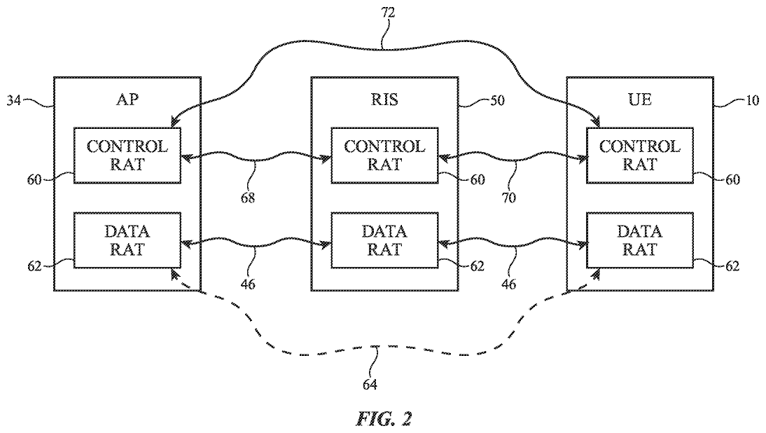

FIG. 2 is a diagram showing how AP 34, RIS 50, and UE device 10 may communicate using both a control RAT and a data transfer RAT for establishing and maintaining communications between AP 34 and UE device 10 via RIS 50. As shown in FIG. 2, AP 34, RIS 50, and UE device 10 may each include wireless circuitry that operates according to a data transfer RAT 62 (sometimes referred to herein as data RAT 62) and a control RAT 60. Data RAT 62 may be a sub-THz communications RAT such as a 6G RAT that performs wireless communications at the frequencies of wireless signals 46. Control RAT 60 may be associated with wireless communications that consume much fewer resources and are less expensive to implement than the communications of data RAT 62. For example, control RAT 60 may be Wi-Fi, Bluetooth, a cellular telephone RAT such as a 3G, 4G, or 5G NR FR1 RAT, etc. As another example control RAT 60 may be an infrared communications RAT (e.g., where an infrared remote control or infrared emitters and sensors use infrared light to convey signals for the control RAT between UE device 10, AP 34, and/or RIS 50).

AP 34 and RIS 50 may use control RAT 60 to convey radio-frequency signals 68 (e.g., control signals) between AP 34 and RIS 50. UE device 10 and RIS 50 may use control RAT 60 to convey radio-frequency signals 70 (e.g., control signals) between UE device 10 and RIS 50. UE device 10, AP 34, and RIS 50 may use data RAT 62 to convey wireless signals 46 via reflection off antenna elements 48 of RIS 50. The wireless signals may be reflected, via the first RIS beam and the second RIS beam formed by RIS 50, between AP 34 and UE device 10. AP 34 may use radio-frequency signals 68 and control RAT 116 and/or UE device 10 may use radio-frequency signals 70 and control RAT 116 to discover RIS 50 and to configure antenna elements 48 to establish and maintain the relay of wireless signals 32 performed by antenna elements 48 using data RAT 62.

If desired, AP 34 and UE device 10 may also use control RAT 60 to convey radio-frequency signals 72 directly with each other (e.g., since the control RAT operates at lower frequencies that do not require line-of-sight). UE device 10 and AP 34 may use radio-frequency signals 72 to help establish and maintain THF communications (communications using data RAT 62) between UE device 10 and AP 34 via RIS 50. AP 34 and UE device 10 may also use data RAT 62 to convey wireless signals 46 directly (e.g., without reflection off RIS 50) when a LOS path is available.

If desired, the same control RAT 60 may be used to convey radio-frequency signals 68 between AP 34 and RIS 50 and to convey radio-frequency signals 70 between RIS 50 and UE device 10. If desired, AP 34, RIS 50, and/or UE device 10 may support multiple control RATs 60. In these scenarios, a first control RAT 60 (e.g., Bluetooth) may be used to convey radio-frequency signals 68 between AP 34 and RIS 50, a second control RAT 60 (e.g., Wi-Fi) may be used to convey radio-frequency signals 70 between RIS 50 and UE device 10, and/or a third control RAT 60 may be used to convey radio-frequency signals 72 between AP 34 and UE device 10. Processing procedures (e.g., work responsibilities) may be divided between data RAT 62 one or more control RAT 60 during discovery, initial configuration, data RAT communication between UE device 10 and AP 34 via RIS 50, and beam tracking of UE device 10.

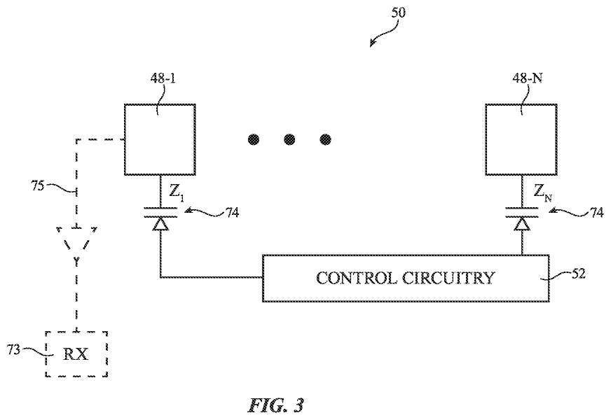

FIG. 3 is a diagram of RIS 50. As shown in FIG. 3, RIS 50 may include a set of N antenna elements 48 (e.g., patches or other structures formed from metal or metamaterials on an underlying substrate). The N antenna elements 48 may be arranged in an array pattern (e.g., having sub-wavelength spacing). Each antenna element 48 may be coupled to a corresponding adjustable device 74. Adjustable devices 74 may include, as one example, a diode switch. Each adjustable device 74 and its corresponding antenna element 48 may sometimes be referred to herein as a unit cell of RIS 50 (e.g., RIS 50 may have N unit cells).

When RIS 50 is an active RIS, one or more antenna element 48 may be coupled to a corresponding receive chain 75 and/or a corresponding transmit chain (not shown). One or more low noise amplifiers and one or more receivers (RX) 73 may be disposed on receive chain 75. Multiple antenna elements 48 may share a receive chain and/or a receiver if desired. Receiver 73 may receive incident wireless signals using antenna element(s) 48. Receiver 73 may, for example, decode or demodulate wireless data from the incident wireless signals. If desired, receiver 73 may gather signal measurements from the incident wireless signals. These measurements may include wireless performance metric values such as received signal power level values, reference signal received power (RSRP) values, reference signal received quality (RSRQ) values, signal-to-noise ratio (SNR) values, or other values characterizing the reception of the wireless signals.

Control circuitry 52 may provide control signals (e.g., a variable voltage) to adjustable devices 74 that configure each adjustable device 74 to impart a selected impedance Z to its corresponding antenna element 48 (e.g., a first impedance Z_{I} for antenna element 48-1, an Nth impedance Z_{N} for antenna element 48-N, etc.). Each impedance may configure the corresponding antenna element 48 to exhibit a particular reflection coefficient for incident signals. By selecting the appropriate settings for adjustable devices 74 and thus impedances Z across the array of antenna elements 48, the array of antenna elements 48 may be configured to form beams in different directions (e.g., to reflect/scatter wireless signals incident from incident angles onto corresponding output angles).

RIS 50 may be operable in three different operating modes (states) sometimes referred to herein as control modes. The mechanism for controlling the operation of RIS 50 (e.g., in reflecting wireless signals 46) is different in each of the control modes. Each control mode may, for example, be associated with a different mechanism for generating/calculating settings for antenna elements 48 and for programming/configuring RIS 50 to implement the generated/calculated settings for antenna elements 48 (e.g., via the corresponding programming/control of adjustable devices 74). For example, the generation and selection of settings for antenna element 48 (e.g., impedances Z, reflection coefficients for antenna elements 48, beamforming settings for antenna elements 48, settings/voltages for adjustable devices 74, etc.) may be generated by RIS 50 itself (e.g., at control circuitry 52) or may be offloaded to an external device (sometimes referred to herein as a RIS controller) such as AP 34 and/or UE device 10.

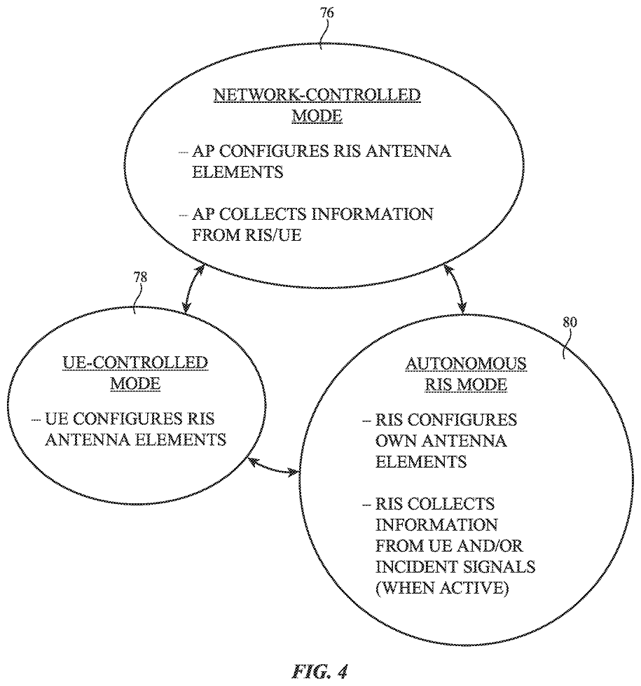

FIG. 4 is a state diagram showing the three operating modes (states) for controlling RIS 50. The operating modes (states) may sometimes be referred to herein as (RIS) control modes or states. As shown in FIG. 4, RIS 50 may be operated in a first control mode (state) such as network-controlled mode 76, a second control mode such as UE-controlled mode 78, and a third control mode such as autonomous RIS mode 80 (sometimes referred to herein as RIS-controlled mode 80 or simply as autonomous mode 80).

In network-controlled mode 76, AP 34 may generate and/or select the settings for antenna elements 48 on RIS 50. AP 34 may transmit control signals (e.g., via the control RAT) that control RIS 50 (e.g., control circuitry 52 of FIG. 3) to configure (program) antenna elements 48 using the generated settings (e.g., by configuring/programming adjustable devices 74). AP 34 may collect information from RIS 50 and/or UE device 10 (e.g., via the control RAT and/or data RAT) and may generate the settings for antenna elements 48 based on the collected information (e.g., such that the settings configure antenna elements 48 to direct its signal beams in the direction of the location of AP 34 and the location of UE device 10). AP 34 may continue to control RIS 50 to update its settings over time (e.g., as additional UE devices attempt to communicate with AP 34, as the UE device moves or leaves, etc.). The RIS controller in this control mode may be deployed or owned by the network, for example (e.g., the network operator associated with AP 34).

In UE-controlled mode 78, UE device 10 may generate and/or select the settings for antenna elements 48 on RIS 50. UE device 10 may transmit control signals (e.g., via the control RAT) that control RIS 50 (e.g., control circuitry 52 of FIG. 3) to configure (program) antenna elements 48 using the generated settings (e.g., by configuring/programming adjustable devices 74). UE device 10 may collect information from RIS 50 and/or AP 34 (e.g., via the control RAT and/or data RAT) and may generate the settings for antenna elements 48 based on the collected information (e.g., such that the settings configure antenna elements 48 to direct its signal beams in the direction of the location of AP 34 and the location of UE device 10). UE device 10 may continue to control RIS 50 to update its settings over time (e.g., as the UE device moves or leaves, etc.). The RIS controller in this control mode may be deployed or owned by the network operator, may be pre-configured by the network operator, or may be separately deployed as an authorized or unauthorized third part component, for example. The network may, for example, authorize the UE device to configure the RIS for a specific operating frequency range including licensed and/or unlicensed spectrum. UE device 10 may pre-configure the RIS or may re-configure the RIS via the RIS controller.

In autonomous RIS mode 78 (sometimes referred to herein as autonomous mode 78 or standalone mode 78), RIS 50 may generate and/or select the settings for its own antenna elements 48. RIS 50 may collect information from UE device 10 and/or AP 34 (e.g., via the control RAT and/or the data RAT when the RIS is an active RIS) and may generate the settings for antenna elements 48 based on the collected information (e.g., such that the settings configure antenna elements 48 to direct its signal beams in the direction of the location of AP 34 and the location of UE device 10). RIS 50 may continue to control itself to update its settings over time (e.g., as the UE device moves or leaves, as more UE devices join, etc.). The RIS controller in this control mode may be deployed or owned by the network operator, may be pre-configured by the network operator, or may be separately deployed as an authorized or unauthorized third part component, for example.

UE device 10, RIS 50, and/or AP 34 may select which of the control modes will be used by RIS 50 at any given time (e.g., based on signals conveyed over the data RAT and/or control RAT). The control mode may be static (e.g., RIS 50 may use the same control mode for the duration of its installation, lifetime, or communication session) and/or may be dynamically adjusted between control modes 76-80 over time (e.g., based on the current needs of the network and/or which of the control modes would optimize the performance of the network at any given time).

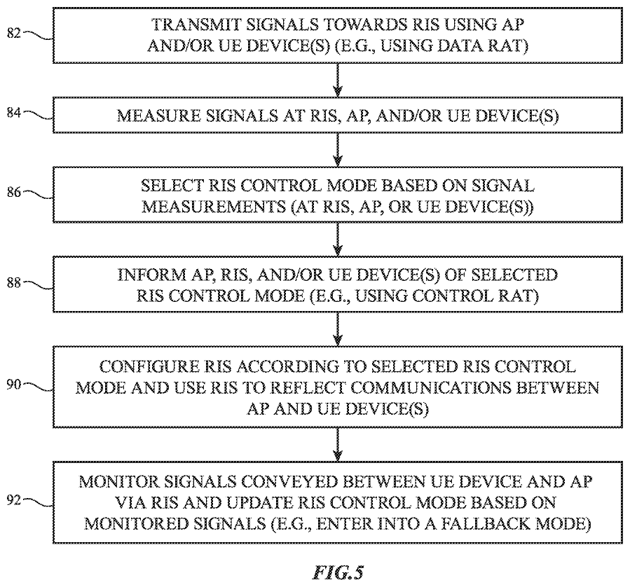

FIG. 5 is a flow chart of operations involved in conveying wireless signals between AP 34 and UE device 10 via reflection off RIS 50. At operation 82, AP 34 may transmit DL signals and/or one or more UE device 10 may transmit UL signals towards RIS 50 (e.g., wireless signals 46 of FIG. 1, transmitted using the data RAT). RIS 50 may reflect DL signals towards UE device(s) 10 and/or back towards AP 34. RIS 50 may reflect UL signals towards AP 34 and/or back towards UE device(s) 10.

At operation 84, UE device(s) 10, AP 34, and/or RIS 50 may measure the signals transmitted by AP 34 and/or UE device(s) 10 (e.g., may gather signal measurements from the transmitted signals). The signal measurements may include wireless performance metric data (e.g., received signal power level values, reference signal received power (RSRP) values, reference signal received quality (RSRQ) values, signal-to-noise ratio (SNR) values, or other values characterizing the reception of the wireless signals) and/or time-of-flight information such as round-trip time (RTT) values.

In some implementations, the transmitted signals may include information identifying the absolute spatial location of AP 34, RIS 50, and/or UE device 10 and/or may include information identifying the relative spatial distance between AP 34 and RIS 50 and/or between RIS 50 and UE device 10. In these implementations, the signal measurements may include identifying, from the transmitted signals, the absolute location of AP 34, RIS 50, and/or UE device 10 and/or the relative distance between AP 34 and RIS 50 and/or between RIS 50 and UE device 10. AP 34, UE device(s) 10, and/or RIS 50 may use the control RAT to exchange the signal measurements between each other if desired.

At operation 86, AP 34, UE device(s) 10, and/or RIS 50 may select the control mode for RIS 50 based on the signal measurements (e.g., network-controlled mode 76, UE-controlled mode 78, or autonomous RIS mode 80 of FIG. 4).

At operation 88, AP 34, UE device(s) 10, and/or RIS 50 may use the control RAT to exchange information identifying the selected control mode between each other.

At operation 90, the antenna elements 48 on RIS 50 may be configured (programmed) according to the selected control mode. For example, when the selected mode is network-controlled mode 76, AP 34 may generate the settings for antenna elements 48 on RIS 50 (e.g., for reflecting communications with the current or expected location of UE device(s) 10) and may use the control RAT to instruct RIS 50 to configure (program) its antenna elements 48 to implement the generated settings. In some implementations, different sets of settings (e.g., for reflecting signals from all possible input directions onto all possible output directions) may be preconfigured and stored on RIS 50 (e.g., a codebook for RIS 50) and AP 34 may simply use the control RAT to instruct RIS 50 to configure its antenna elements 48 using a selected one of the stored sets of settings (e.g., for reflecting communications with the current or expected location of UE device(s) 10).

When the selected mode is UE-controlled mode 78, one or more UE device 10 may generate the settings for antenna elements 48 on RIS 50 (e.g., for reflecting communications with the current or expected location of UE device(s) 10) and may use the control RAT to instruct RIS 50 to configure (program) its antenna elements 48 to implement the generated settings. In implementations where different sets of settings (e.g., for reflecting signals from all possible input directions onto all possible output directions) are preconfigured and stored on RIS 50 (e.g., the codebook for RIS 50), UE device(s) 10 may simply use the control RAT to instruct RIS 50 to configure its antenna elements 48 using a selected one of the stored sets of settings (e.g., for reflecting communications between AP 34 and the current or expected location of UE device(s) 10).

When the selected mode is autonomous RIS mode 80, RIS 50 may generate the settings for its own antenna elements 48 on RIS 50 (e.g., for reflecting communications with the current or expected location of UE device(s) 10). In implementations where different sets of settings (e.g., for reflecting signals from all possible input directions onto all possible output directions) are preconfigured and stored on RIS 50 (e.g., a codebook for RIS 50), control circuitry 52 on RIS 50 may calculate which of the sets of settings to select and may then configure its antenna elements 48 using the selected one of the stored sets of settings (e.g., for reflecting communications between AP 34 and the current or expected location of UE device(s) 10). Once RIS 50 has been placed in the selected control mode, AP 34 and/or UE device(s) 10 may transmit wireless signals 46 (using the data RAT) that are reflected off RIS 50. By this point, the RIS controller has already programmed the RIS to reflect wireless signals 46 between AP 34 and UE device(s) 10.

At operation 92, AP 34, RIS 50, and/or UE device(s) 10 may monitor the signals conveyed between UE device(s) 10 and AP 34 and reflected off RIS 50. AP 34, RIS 50, and/or UE device(s) 10 may update the RIS control mode based on the monitored signals. For example, AP 34, RIS 50, and/or UE device(s) 10 may gather signal measurements from the transmitted and/or reflected signals and may update the RIS control mode based on the gathered signal measurements. The updated RIS control mode may be selected using the same operations as operation 86 or, if desired, RIS 50 may be placed in a fallback control mode. The fallback control mode may be one of control modes 76-80 and may, in some instances, depend on the deployment of RIS 50.

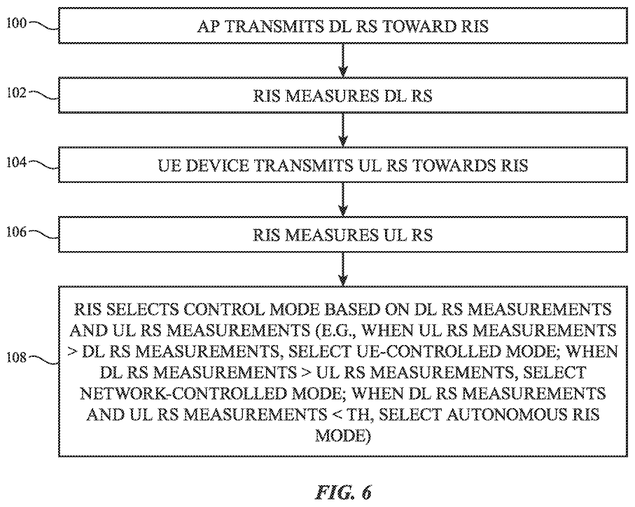

FIG. 6 is a flow chart of operations involved in selecting the control mode for RIS 50 at RIS 50 (e.g., in an implementation where RIS 50 is an active RIS that selects the control mode). The operations of FIG. 6 may, for example, be performed while processing operations 82-86 of FIG. 5. The control RAT may be used to coordinate transmissions between UE device 10 and AP 34 as well as to configure RIS 50 to perform the operations of FIG. 6.

At operation 100, AP 34 may transmit DL signals towards RIS 50. The DL signals may be any desired DL signals (e.g., DL signals that do not include wireless data for reception at UE device 10). An implementation in which the DL signals include a DL reference signal (RS) is described herein as an example. AP 34 and/or UE device 10 may use the control RAT to instruct RIS 50 to receive and measure the DL RS.

At operation 102, one or more antenna elements 48 on RIS 50 may receive the DL RS transmitted by AP 34. Receiver 73 (FIG. 3) may decode the DL RS and/or may gather signal measurements from the DL RS (sometimes referred to herein as DL RS measurements). The DL RS measurements may include first wireless performance metric data, for example.

At operation 104, UE device 10 may transmit UL signals towards RIS 50. The UL signals may be any desired UL signals (e.g., UL signals that do not include wireless data for reception at AP 34). An implementation in which the UL signals include a UL reference signal (RS) is described herein as an example.

At operation 104, one or more antenna elements 48 on RIS 50 may receive the UL RS transmitted by UE device 10. Receiver 73 (FIG. 3) may decode the UL RS and/or may gather signal measurements from the UL RS (sometimes referred to herein as UL RS measurements). The UL RS measurements may include second wireless performance metric data, for example.

At operation 108, control circuitry 52 on RIS 50 may select the control mode for RIS 50 based on the UL RS measurements (e.g., first wireless performance metric data as gathered at operation 106) and the DL RS measurements (e.g., second wireless performance metric data as gathered at operation 102). This may involve a comparison of the UL RS measurements to the DL RS measurements and/or a comparison of the UL RS measurements and/or the DL RS measurements to one or more threshold values.

For example, when the UL RS measurements are characteristic of better wireless performance than the DL RS measurements (e.g., higher RSRQ, RSRP, or SNR values), RIS 50 may select UE-controlled mode 78. When the DL RS measurements are characteristic of better wireless performance than the UL RS measurements, RIS 50 may select network-controlled mode 76. When both the UL RS measurements and the DL RS measurements fall below a threshold value TH, RIS 50 may select autonomous RIS mode 80. If desired, when both the UL RS measurements and the DL RS measurements are above threshold value TH, RIS 50 may select either network-controlled mode 76 or UE-controlled mode 78 (e.g., based on a policy dictated by the network and/or UE device 10 and/or instructed to RIS 50 via the control RAT). If desired, the UL RS measurements and the DL RS measurements may be compared to different respective threshold values (e.g., the network-controlled mode may be selected when the DL RS measurements are above a first minimum threshold but the UL RS measurements are below a second minimum threshold, the UE-controlled mode may be selected when the UL RS measurements are above a first minimum threshold but the UL RS measurements are below a second minimum threshold, the autonomous RIS mode may be selected when the UL RS measurements are below a first minimum threshold and the DL RS measurements are below a second minimum threshold, etc.).

Once RIS 50 has selected the control mode, RIS 50 may use the control RAT to report the selected control mode to AP 34 and/or UE device 10. In general, any desired comparison logic may be used to select the control mode at operation 108. If desired, the roles of the AP and the UE device in FIG. 6 may be swapped.

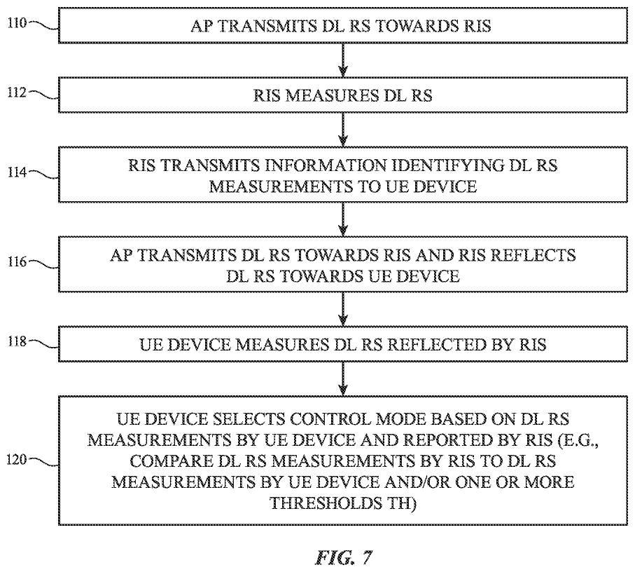

FIG. 7 is a flow chart of operations involved in selecting the control mode for RIS 50 at UE device 10 (e.g., in an implementation where UE device 10 selects the control mode). The operations of FIG. 7 may, for example, be performed while processing operations 82-86 of FIG. 5. The control RAT may be used to coordinate transmissions between UE device 10 and AP 34 as well as to configure RIS 50 to perform the operations of FIG. 7.

At operation 110, AP 34 may transmit DL signals towards RIS 50. The DL signals may be any desired DL signals (e.g., DL signals that do not include wireless data for reception at UE device 10). An implementation in which the DL signals include a DL reference signal (RS) is described herein as an example. AP 34 and/or UE device 10 may use the control RAT to instruct RIS 50 to receive and measure the DL RS.

At operation 112, one or more antenna elements 48 on RIS 50 may receive the DL RS transmitted by AP 34. Receiver 73 (FIG. 3) may decode the DL RS and/or may gather signal measurements from the DL RS (sometimes referred to herein as first DL RS measurements). The first DL RS measurements may include first wireless performance metric data, for example.

At operation 114, RIS 50 may use the control RAT to transmit the DL RS measurements to UE device 10 (e.g., in a measurement report or any other message including information that identifies the DL RS measurements). UE device 10 may store the DL RS measurements received from RIS 50 for subsequent processing.

At operation 116, AP 34 or UE device 10 may use the control RAT to instruct (configure) RIS 50 to reflect subsequent wireless signals 46 to UE device 10. AP 34 may then transmit DL signals towards RIS 50. The DL signals may be any desired DL signals (e.g., DL signals that do not include wireless data for reception at UE device 10). An implementation in which the DL signals include a DL reference signal (RS) is described herein as an example. RIS 50 may reflect the incident DL RS towards UE device 10.

At operation 118, UE device 10 may receive the DL RS transmitted by AP 34 and reflected by RIS 50. UE device 10 may gather signal measurements from the DL RS (sometimes referred to herein as second DL RS measurements). The second DL RS measurements may include second wireless performance metric data, for example.

At operation 120, control circuitry 14 on UE device 10 may select the control mode for RIS 50 based on the first DL RS measurements (e.g., first wireless performance metric data as reported to UE device 10 by RIS 50 at operation 114) and the second DL RS measurements (e.g., second wireless performance metric data as gathered at operation 118). This may involve a comparison of the first DL RS measurements to the second DL RS measurements and/or a comparison of the first and/or second DL RS measurements to one or more threshold values.

For example, when the first DL RS measurements are characteristic of better wireless performance than the second DL RS measurements (e.g., higher RSRQ, RSRP, or SNR values), UE device 10 may select autonomous mode 80 or network-controlled mode 76. When the second DL RS measurements are characteristic of better wireless performance than the first DL RS measurements, UE device 10 may select UE-controlled mode 78. When both the first DL RS measurements and the second DL RS measurements fall below a threshold value TH, UE device 10 may select network-controlled mode 76. If desired, when both the first DL RS measurements and the second DL RS measurements are above threshold value TH, UE device 10 may select either autonomous mode 80 or UE-controlled mode 78 (e.g., based on a policy dictated by the network and/or UE device 10). If desired, the first DL RS measurements and the second DL RS measurements may be compared to different respective threshold values (e.g., the autonomous mode may be selected when the first DL RS measurements are above a first minimum threshold but the second DL RS measurements are below a second minimum threshold, the UE-controlled mode may be selected when the second DL RS measurements are above a first minimum threshold but the first DL RS measurements are below a second minimum threshold, the network-controlled mode may be selected when the first DL RS measurements are below a first minimum threshold and the second DL RS measurements are below a second minimum threshold, etc.).

Once UE device 10 has selected the control mode, UE device 10 may use the control RAT to report the selected control mode to AP 34 and/or RIS 50. In general, any desired comparison logic may be used to select the control mode at operation 120. If desired, the roles of the AP and the UE device in FIG. 7 may be swapped.

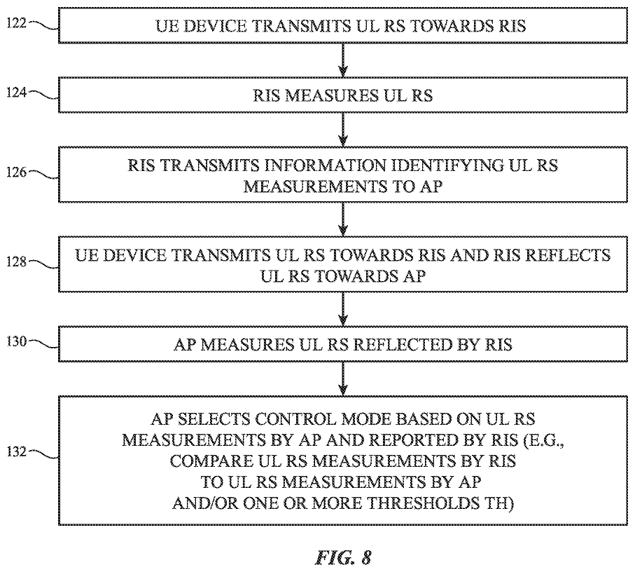

FIG. 8 is a flow chart of operations involved in selecting the control mode for RIS 50 at AP 34 (e.g., in an implementation where AP 34, sometimes referred to herein as the network, selects the control mode). The operations of FIG. 8 may, for example, be performed while processing operations 82-86 of FIG. 5. The control RAT may be used to coordinate transmissions between UE device 10 and AP 34 as well as to configure RIS 50 to perform the operations of FIG. 8.

At operation 122, UE device 10 may transmit UL signals towards RIS 50. The UL signals may be any desired UL signals (e.g., UL signals that do not include wireless data for reception at AP 34). An implementation in which the UL signals include a UL reference signal (RS) is described herein as an example. AP 34 and/or UE device 10 may use the control RAT to instruct RIS 50 to receive and measure the UL RS.

At operation 124, one or more antenna elements 48 on RIS 50 may receive the UL RS transmitted by AP 34. Receiver 73 (FIG. 3) may decode the UL RS and/or may gather signal measurements from the UL RS (sometimes referred to herein as first UL RS measurements). The first UL RS measurements may include first wireless performance metric data, for example.

At operation 126, RIS 50 may use the control RAT to transmit the UL RS measurements to AP 34 (e.g., in a measurement report or any other message including information that identifies the UL RS measurements). AP 34 may store the UL RS measurements received from RIS 50 for subsequent processing.

At operation 128, UE device 10 or AP 34 may use the control RAT to instruct (configure) RIS 50 to reflect subsequent wireless signals 46 to AP 34. UE device 10 may then transmit UL signals towards RIS 50. The UL signals may be any desired UL signals (e.g., UL signals that do not include wireless data for reception at AP 34). An implementation in which the UL signals include a UL reference signal (RS) is described herein as an example. RIS 50 may reflect the incident UL RS towards AP 34.

At operation 130, AP 34 may receive the UL RS transmitted by UE device 10 and reflected by RIS 50. AP 34 may gather signal measurements from the UL RS (sometimes referred to herein as second UL RS measurements). The second UL RS measurements may include second wireless performance metric data, for example.

At operation 132, control circuitry 36 on AP 34 may select the control mode for RIS 50 based on the first UL RS measurements (e.g., first wireless performance metric data as reported to UE device 10 by RIS 50 at operation 126) and the second UL RS measurements (e.g., second wireless performance metric data as gathered at operation 130). This may involve a comparison of the first UL RS measurements to the second UL RS measurements and/or a comparison of the first and/or second UL RS measurements to one or more threshold values.

For example, when the first UL RS measurements are characteristic of better wireless performance than the second UL RS measurements (e.g., higher RSRQ, RSRP, or SNR values), AP 34 may select autonomous mode 80. When the second UL RS measurements are characteristic of better wireless performance than the first UL RS measurements, AP 34 may select network-controlled mode 76. When both the first UL RS measurements and the second UL RS measurements fall below a threshold value TH, AP 34 may select UE-controlled mode 78. If desired, when both the first UL RS measurements and the second UL RS measurements are above threshold value TH, AP 34 may select either autonomous mode 80 or network-controlled mode 76 (e.g., based on a policy dictated by the network and/or UE device 10). If desired, the first UL RS measurements and the second UL RS measurements may be compared to different respective threshold values (e.g., the autonomous mode may be selected when the first UL RS measurements are above a first minimum threshold but the second UL RS measurements are below a second minimum threshold, the network-controlled mode may be selected when the second UL RS measurements are above a first minimum threshold but the first UL RS measurements are below a second minimum threshold, the UE-controlled mode may be selected when the first UL RS measurements are below a first minimum threshold and the second UL RS measurements are below a second minimum threshold, etc.).

Once AP 34 has selected the control mode, AP 34 may use the control RAT to report the selected control mode to UE device 10 and/or RIS 50. In general, any desired comparison logic may be used to select the control mode at operation 120. If desired, the roles of the AP and the UE device in FIG. 8 may be swapped.

While wireless signals are being conveyed between AP 34 and UE device 10 via reflection off RIS 50, the network may use the control RAT to configure RIS 50 and/or UE device 10 to monitor the control mode for RIS 50 (e.g., while processing operation 92 of FIG. 5). This may involve RIS 50 and/or UE device 10 gathering signal measurements such as wireless performance metric data (e.g., using the data RAT). For example, if the measurement quality while RIS 50 operates under the current control mode drops below a threshold level, the control mode can be updated. The control mode may be updated using any of the operations of FIGS. 6-8, for example.

If desired, when the measurement quality (e.g., wireless performance metric data) drops below the threshold level, the control mode can be changed to a fallback mode. In one implementation, network-controlled mode 76 may be the fallback mode. In other implementations, the fallback mode may depend on the deployment of the RIS. For example, if the RIS is deployed by the network, network-controlled mode 76 may be the fallback mode. If the RIS is deployed by an end user, UE-controlled mode 78 may be the fallback mode. If the RIS is deployed by a third-party such as an enterprise owner, network-controlled mode 76 may be the fallback mode.

If desired, multiple UE devices 10 may be considered to act as the UE-controller of RIS 50 (e.g., in the UE-controlled mode). For example, RIS 50 may be configured to perform measurements corresponding to multiple UE devices (e.g., during processing of FIGS. 5-8) and may determine the best set of UE devices, which can include one or more UE devices, to then control the UE device in the UE-controlled mode. The network or RIS 50 may select the UE device(s) to perform controlling in the UE-controlled mode, if desired. For example, the RIS may report the UE that produced the best measurements to serve as its UE controller. As another example, the RIS may report to the network the UE device that produced the strongest measurements and the network can indicate that UE. In one embodiment, the RIS may report multiple UE devices for consideration to serve as the controller of the RIS. If desired, the network may configure one or more UE devices 10 to control the RIS. Additional coordination (e.g., over the control RAT) may be performed in implementations where the RIS is controlled by multiple UE devices.

Similarly, in implementations where RIS 50 is controlled by AP 34, multiple APs may be considered to control the RIS. If desired, the RIS and the UE device can be configured to perform measurements from signals transmitted by multiple APs (e.g., during processing of FIGS. 5-8) and then the best set of APs can be identified and the controlling AP selected from that set. The network may decide when and how to select the APs used to control RIS 50.

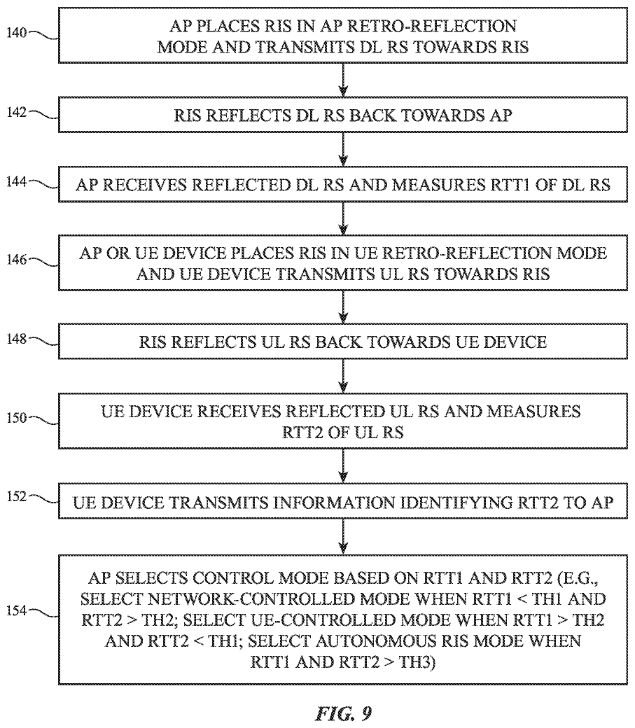

If desired, AP 34 may select the control mode for RIS 50 based on RTT values. FIG. 9 is a flow chart of operations involved in selecting the control mode at AP 34 using RTT values. The operations of FIG. 9 may, for example, be performed while processing operations 82-86 of FIG. 5. The control RAT may be used to coordinate transmissions between UE device 10 and AP 34 as well as to configure RIS 50 to perform the operations of FIG. 9.

At operation 140, AP 34 may use the control RAT to place RIS 50 into a first retro-reflection mode, sometimes referred to herein as an AP retro-reflection mode. In the AP retro-reflection mode, the antenna elements 48 on RIS 50 are configured to reflect signals incident from AP 34 back towards AP 34 (e.g., both RIS beams formed by the RIS may be oriented towards AP 34). While RIS 50 is in the AP retro-reflection mode, AP 34 may transmit DL signals towards RIS 50. The DL signals may be any desired DL signals (e.g., DL signals that do not include wireless data for reception at UE device 10). An implementation in which the DL signals include a DL reference signal (RS) is described herein as an example.

At operation 142, RIS 50 may reflect the incident DL RS back towards AP 34.

At operation 144, AP 34 may receive the reflected DL RS. AP 34 may transmit the DL RS and may receive the reflected DL RS using the same signal beam or using separate transmit and receive beams. If desired, a first AP 34 may transmit the DL RS whereas a second AP receives the reflected DL RS. AP 34 may measure time-of-flight information for the reflected DL RS based on the transmitted DL RS and the received reflected DL RS. For example, AP 34 may measure (e.g., generate, calculate, compute, gather, produce, output, etc.) a first round trip time (RTT1) of the DL RS, which characterizes the amount of time it took for the transmitted DL RS to reach RIS 50, to reflect off RIS 50, and to be received back at AP 34.

At operation 146, AP 34 and/or UE device 10 may use the control RAT to place RIS 50 into a second retro-reflection mode, sometimes referred to herein as a UE retro-reflection mode. In the UE retro-reflection mode, the antenna elements 48 on RIS 50 are configured to reflect signals incident from UE device 10 back towards UE device 10 (e.g., both RIS beams formed by the RIS may be oriented towards UE device 10). While RIS 50 is in the UE retro-reflection mode, UE device 10 may transmit UL signals towards RIS 50. The UL signals may be any desired UL signals (e.g., UL signals that do not include wireless data for reception at AP 34). An implementation in which the UL signals include a UL reference signal (RS) is described herein as an example.

At operation 148, RIS 50 may receive and reflect the UL RS back towards UE device 10.

At operation 150, UE device 10 may receive the reflected UL RS. UE device 10 may measure time-of-flight information for the reflected UL RS based on the transmitted UL RS and the received reflected UL RS. For example, AP 34 may measure a second round trip time (RTT2) of the UL RS, which characterizes the amount of time it took for the transmitted UL RS to reach RIS 50, to reflect off RIS 50, and to be received back at UE device 10.

At operation 152, UE device 10 may use the control RAT to transmit information (e.g., a report or message) identifying the second round trip time RTT2 to AP 34.

At operation 154, AP 34 may select the control mode for RIS 50 based on the first round trip time RTT1 and the second round trip time RTT2. This may involve a comparison of the first round trip time RTT1 to the second round trip time RTT2 and/or a comparison of the first and/or second round trip times to one or more threshold values.

For example, when the first round trip time RTT1 is less than the second round trip time RTT2, AP 34 may select network-controlled mode 76. When the second round trip time RTT2 is less than the first round trip time RTT1, AP 34 may select UE-controlled mode 78 (e.g., AP 34 may select the device having the lower RTT to control RIS 50, which may be associated with less control latency, etc.). When both the first round trip time RTT1 and the second round trip time RTT2 exceed a threshold value, AP 34 may select autonomous mode 80. If desired, when both the first round trip time RTT1 and the second round trip time RTT2 are above below the threshold value, AP 34 may select either network-controlled mode 76 or UE-controlled mode 78 (e.g., based on a policy dictated by the network and/or UE device 10). If desired, RTT1 and RTT2 may be compared to different respective threshold values (e.g., the network-controlled mode may be selected when RTT1 is less than threshold TH1 and RTT2 is greater than threshold TH2, the UE-controlled mode may be selected when RTT1 is greater than threshold TH2 and RTT2 is less than threshold RTT2, the autonomous mode may be selected when RTT1 and RTT2 both exceed a threshold TH3, etc.).

Once AP 34 has selected the control mode, AP 34 may use the control RAT to report the selected control mode to UE device 10 and/or RIS 50. In general, any desired comparison logic may be used to select the control mode at operation 154. If desired, the roles of the AP and the UE device in FIG. 9 may be swapped. Selecting the control mode based on RTT may be particularly useful when RIS 50 is a passive RIS, since no data RAT measurements need to be performed at RIS 50. In other implementations, RTT1 and RTT2 may be estimated using radio-frequency sensing/ranging (e.g., using a radar waveform transmitted by UE device 10 towards RIS 50 and/or by AP 34 towards RIS 50). If desired, sub-band full-duplex mode may be applied at AP 34 and/or UE device 10 for transmission of signals and reception of reflected signals on the same time resources. For example, one set of sub-bands on a given symbol may be used to transmit the signals whereas another non-overlapping set of sub-bands on the same symbol are used to receive the reflected signals.

While wireless signals are being conveyed between AP 34 and UE device 10 via reflection off RIS 50, the network may use the control RAT to configure RIS 50 and/or UE device 10 to monitor the control mode for RIS 50 (e.g., while processing operation 92 of FIG. 5). This may involve RIS 50 and/or UE device 10 gathering RTT values (e.g., using the data RAT). For example, if the RTT value while RIS 50 operates under the current control mode rises above a threshold level, the control mode can be updated (e.g., using any of the operations of FIGS. 6-9).

If desired, when the RTT in the current control mode exceeds a threshold level, the RIS 50 may be placed in the fallback mode. In one implementation, network-controlled mode 76 may be the fallback mode. In other implementations, the fallback mode may depend on the deployment of the RIS. For example, if the RIS is deployed by the network, network-controlled mode 76 may be the fallback mode. If the RIS is deployed by an end user, UE-controlled mode 78 may be the fallback mode. If the RIS is deployed by a third-party such as an enterprise owner, network-controlled mode 76 may be the fallback mode.

The operations of FIG. 9 may be adapted to implementations where multiple UE devices are used to control the RIS. The network may, for example, configure multiple UE devices 10 to generate RTT values relative to RIS 50, to identify a set of best performing UE devices, and to select one of the UE devices from the set to serve as the controller for the RIS. The operations of FIG. 9 may also be adapted to implementations where multiple APs are used to control the RIS. The network may, for example, configure multiple APs 34 to generate RTT values relative to RIS 50, to identify a set of best performing APs, and to select one of the APs from the set to serve as the controller for the RIS.

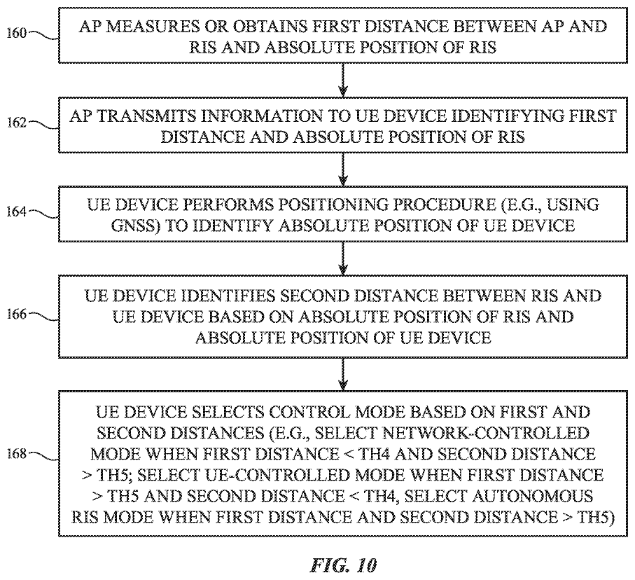

If desired, UE device 10 may select the control mode for RIS 50 based on the distance between AP 34 and RIS 50 and the distance between UE device 10 and RIS 50. FIG. 10 is a flow chart of operations involved in selecting the control mode at UE device 10 using distances. The operations of FIG. 10 may, for example, be performed while processing operations 82-86 of FIG. 5. The control RAT may be used to coordinate transmissions between UE device 10 and AP 34 as well as to configure RIS 50 to perform the operations of FIG. 10.

At operation 160, AP 34 may measure or obtain a first distance (range) between AP 34 and RIS 50. For example, AP 34 may transmit spatial ranging (sensing) signals (e.g., radar signals) and may measure the distance between AP 34 and RIS 50 using the ranging signals. AP 34 may also measure or obtain the absolute position of RIS 50. For example, an administrator who deployed RIS 50 may provide AP 34 with its absolute position (location), AP 34 may deduce the location based on the first distance, the known position of AP 34, and the angle-of-arrival of the ranging signals, additional sensors on AP 34, RIS 50, or another device may identify the absolute position of RIS 50, RIS 50 may use the control RAT to inform AP 34 of its absolute position, etc.

At operation 162, AP 34 may use the control RAT to transmit information to UE device 10 identifying the first distance and the absolute position of RIS 50.

At operation 164, UE device 10 may perform a positioning procedure to identify its absolute position. This may involve using a global navigation satellite system (GNSS) receiver such as a GPS receiver to identify the geographic location (coordinates) of UE device 10 and/or the network informing UE device 10 of its absolute location. Additionally or alternatively, spatial ranging signals and/or other sensor data may be used to identify the absolute position of UE device 10.

At operation 166, UE device 10 may identify a second distance (range) between UE device 10 and RIS 50 based on the absolute position of the RIS and the absolute position of UE device 10 (e.g., by computing the distance between the two absolute locations).

At operation 168, UE device 10 may select the control mode for RIS 50 based on the first distance and the second distance. This may involve a comparison of the first distance to the second distance and/or a comparison of the first and/or second distances to one or more threshold values.

For example, when the first distance is less than the second distance, UE device 10 may select network-controlled mode 76. When the second distance is less than the first distance, UE device 10 may select UE-controlled mode 78 (e.g., UE device 10 may select the device that is closer to RIS 50 to control RIS 50, which may be associated with less control latency, etc.). When both the first distance and the second distance exceed a threshold value, UE device 10 may select autonomous mode 80. If desired, when both the first distance and the second distance are below the threshold value, UE device 10 may select either network-controlled mode 76 or UE-controlled mode 78 (e.g., based on a policy dictated by the network and/or UE device 10). If desired, the first and second distance may be compared to different respective threshold values (e.g., the network-controlled mode may be selected when the first distance is less than threshold TH4 and the second distance is greater than threshold TH5, the UE-controlled mode may be selected when the first distance is greater than threshold TH5 and the second distance is less than threshold TH4, the autonomous mode may be selected when the first and second distances both exceed threshold TH5, etc.).

Once UE device 10 has selected the control mode, UE device 10 may use the control RAT to report the selected control mode to UE device 10 and/or RIS 50. In general, any desired comparison logic may be used to select the control mode at operation 168. If desired, the roles of the AP and the UE device in FIG. 10 may be swapped.

While wireless signals are being conveyed between AP 34 and UE device 10 via reflection off RIS 50, the network may use the control RAT to configure RIS 50 and/or UE device 10 to monitor the control mode for RIS 50 (e.g., while processing operation 92 of FIG. 5). This may involve RIS 50 and/or UE device 10 gathering distance values (e.g., using the data RAT). For example, if the distance value between the controlling device and RIS 50 rises above a threshold level, the control mode can be updated (e.g., using any of the operations of FIGS. 6-10). If desired, when the distance in the current control mode exceeds the threshold level, RIS 50 may be placed in the fallback mode.

In any of the control modes, the RIS-controlling device may program sets or groups of antenna elements rather than individual elements if desired (e.g., to save power on the RIS). The RIS may transmit control signals to the controlling device informing the RIS-controlling device of its capabilities. The capabilities may include geometry (architecture) details about the RIS and/or its antenna elements. The controlling device may program the groups of elements based on the capabilities. If desired, the RIS-controlling device may gather signal measurements during wireless communications and may use the measurements to update the programming. For example, the RIS-controlling device may include the number of active antenna elements on the RIS or included in the groups that are programmed (e.g., as the measurement quality decreases the number of antenna elements included in the groups and/or activated may be increased). The arrangement of the groups of antenna elements that are programmed may be referred to as the panel configuration. If desired, the panel configuration may be determined based on the reference carrier frequency reported by the RIS and the actual operating carrier frequency. If desired, the operating carrier frequency may always be greater than or equal to the reference carrier frequency. If desired, the operating carrier frequency may increase relative to the reference carrier frequency, the number of elements within a panel may be increased for the updated RIS panel configuration in comparison to the reference RIS panel configuration. If desired, for a single panel configuration, if the operating frequency is increased relative to the reference carrier frequency, then the required panels that are activated are also increased corresponding to the number of required panels to be activated for reference carrier frequency.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent with.” While described herein as redirecting wireless signals via reflection for the sake of simplicity, RIS 50 may equivalently redirect wireless signals via transmission (e.g., by transmitting the signals through the RIS onto a desired output angle that is adjusted by adjusting the impedance responses of the antenna elements on the RIS).

UE device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-10 may be performed by the components of UE device 10, RIS 50, and/or AP 34 using software, firmware, and/or hardware (e.g., dedicated circuitry or hardware). Software code for performing these operations may be stored on non-transitory computer readable storage media (e.g., tangible computer readable storage media) stored on one or more of the components of UE device 10, RIS 50, and/or AP 34. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of UE device 10, RIS 50, and/or AP 34. The processing circuitry may include microprocessors, central processing units (CPUs), application-specific integrated circuits with processing circuitry, or other processing circuitry.

For one or more aspects, at least one of the components set forth in one or more of the preceding figures may be configured to perform one or more operations, techniques, processes, or methods as set forth herein. For example, the control circuitry as described above in connection with one or more of the preceding figures may be configured to operate in accordance with one or more of the examples set forth herein. For another example, circuitry associated with a UE device, AP, RIS, network element, etc. as described above in connection with one or more of the preceding figures may be configured to operate in accordance with one or more of the examples set forth herein.

An apparatus (e.g., an electronic user equipment device, a wireless access point, a RIS, etc.) may be provided that includes means to perform one or more elements of a method described in or related to any of the methods or processes described herein.

One or more non-transitory computer-readable media comprising instructions to cause an electronic device, upon execution of the instructions by one or more processors of the electronic device, to perform one or more elements of any method or process described herein.

An apparatus comprising logic, modules, or circuitry to perform one or more elements of a method described in or related to any of the method or process described herein.

An apparatus comprising: one or more processors and one or more non-transitory computer-readable storage media comprising instructions that, when executed by the one or more processors, cause the one or more processors to perform the method, techniques, or process as described herein.

A signal, datagram, information element, packet, frame, segment, PDU, or message or datagram may be provided as described in or related to any of the examples described herein.

A signal encoded with data, a datagram, IE, packet, frame, segment, PDU, or message may be provided as described in or related to any of the examples described herein.

An electromagnetic signal may be provided carrying computer-readable instructions, wherein execution of the computer-readable instructions by one or more processors is to cause the one or more processors to perform the method, techniques, or process as described in or related to any of the examples described herein.

A computer program comprising instructions, wherein execution of the program by a processing element is to cause the processing element to carry out the method, techniques, or process as described in or related to any of the examples described herein.

A signal in a wireless network as shown and described herein may be provided.

A method of communicating in a wireless network as shown and described herein may be provided.

A system for providing wireless communication as shown and described herein may be provided.

A device for providing wireless communication as shown and described herein may be provided.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed.

The foregoing is merely illustrative and various modifications can be made to the described embodiments. The foregoing embodiments may be implemented individually or in any combination.

What is claimed is:

1. A first electronic device configured to operate on wireless signals conveyed between a second electronic device and a third electronic device, the first electronic device comprising:
an array of scattering elements;
adjustable devices coupled to the array of scattering elements; and
one or more processors, the one or more processors being configured to,
at a first time, program the adjustable devices, and
at a second time, program the adjustable devices based on a control signal received from the second electronic device.

2. The first electronic device of claim 1 wherein, at the first time, the one or more processors are configured to autonomously program the adjustable devices without input from the first electronic device or the second electronic device.

3. The first electronic device of claim 1, wherein the adjustable devices comprise diodes, the one or more processors being configured to program the adjustable devices by supplying voltages to the diodes.

4. The first electronic device of claim 1, the adjustable devices being configured to impart a first set of impedances to the array of scattering elements at the first time and the adjustable devices being configured to impart a second set of impedances to the array of scattering elements at the second time.

5. The first electronic device of claim 4, the array of scattering elements being configured to reflect the wireless signals in a first direction at the first time and in a second direction at the second time.

6. The first electronic device of claim 1, further comprising:
a receiver coupled to one or more scattering elements in the array of scattering elements.

7. The first electronic device of claim 6, wherein the receiver is configured to measure, using the one or more scattering elements, a downlink (DL) signal transmitted by the second electronic device.

8. The first electronic device of claim 7, further comprising an antenna configured to transmit, to the third electronic device, a message identifying the measurement of the DL signal.

9. The first electronic device of claim 7, wherein the receiver is configured to measure, using the one or more scattering elements, an uplink (UL) signal transmitted by the third electronic device.

10. The first electronic device of claim 8, further comprising an antenna configured to transmit a message instructing the second electronic device or the third electronic device to control the RIS.

11. A method of operating a reconfigurable intelligent surface (RIS) to redirect radio-frequency signals between a first electronic device and a second electronic device, the method comprising:
performing, using a receiver, a first measurement on the radio-frequency signals;
transmitting, using a transmitter, a report identifying the first measurement to the first electronic device;
reflecting, using antenna elements, a reference signal transmitted by the second electronic device; and
receiving, using the receiver, a signal from the first electronic device that identifies a control mode of the RIS, the control mode being selected by the first electronic device based on the reference signal reflected by the antenna elements and the report transmitted by the transmitter.

12. The method of claim 11, wherein the reference signal comprises a downlink (DL) reference signal, the first electronic device comprises a user equipment device, and the second electronic device comprises a wireless access point or a wireless base station.

13. The method of claim 11, wherein the reference signal comprises an uplink (UL) reference signal, the first electronic device comprises a wireless access point or a wireless base station, and the second electronic device comprises a user equipment device.

14. The method of claim 11, wherein the control mode comprises a control mode in which the first electronic device controls the RIS.

15. The method of claim 11, wherein the control mode comprises a control mode in which the second electronic device controls the RIS.

16. The method of claim 11, wherein the control mode comprises a control mode in which the RIS controls itself.

17. The method of claim 11, wherein transmitting the report comprises transmitting the report using a first radio access technology (RAT), reflecting the reference signal comprises reflecting the reference using a second RAT that is different from the first RAT, and receiving the signal comprises receiving the signal using the first RAT.

18. A method of operating a reconfigurable intelligent surface (RIS), the method comprising:
performing, using a receiver, a first measurement on a first reference signal transmitted by a first electronic device;
performing, using a receiver, a second measurement on a second reference signal transmitted by a second electronic device;
transmitting, using a transmitter, information to the first electronic device identifying a control mode of the RIS, the control mode being selected by one or more processors on the RIS based on the first measurement and the second measurement; and
redirecting, using antenna elements, radio-frequency signals between the first electronic device and the second electronic device while adjustable devices coupled to the antenna elements are configured based on the control mode.

19. The method of claim 18, wherein the first reference signal comprises an uplink reference signal and the second reference signal comprises a downlink reference signal.

20. The method of claim 18, wherein the control mode comprises a control mode in which a selected one of the RIS, the first electronic device, or the second electronic device sets the adjustable devices.
